(19) United States
(12) Patent Application Publication
(10) Pub. No.: US 2018/0365696 A1
(43) Pub. Date: Dec. 20, 2018

(54) FINANCIAL FRAUD DETECTION USING USER GROUP BEHAVIOR ANALYSIS

(71) Applicant: NEC Laboratories America, Inc., Princeton, NJ (US)

(72) Inventors: Tan Yan, Skillman, NJ (US); Haifeng Chen, West Windsor, NJ (US); Ajiro Yasuhiro, Tokyo (JP)

(21) Appl. No.: 15/982,496

(22) Filed: May 17, 2018

Related U.S. Application Data
(60) Provisional application No. 62/521,597, filed on Jun. 19, 2017.

(51) Int. Cl. G06Q 20/40; H04L 29/06; H04L 12/58; H04L 29/08; G06K 9/62

(52) U.S. Cl. CPC G06Q 20/4016; H04L 63/1425; G06K 9/6223; H04L 67/22; H04L 51/046

(57) ABSTRACT

Systems and methods for mitigating fraud in transactions including clustering account holders into groups with a cluster generator by jointly considering account activities as features in a clustering algorithm such that account holders in each group have similar behavior according to analysis of the features in the clustering algorithm. In each group, a list of suspicious transactions is detected with a suspicious behavior detector by determining outlier transactions for a transaction type of interest relative to transactions of each account holder in a group. An alert is generated and sent to users with a fraud suspicion response system to mitigate the suspicious transactions.

### RELATED APPLICATION INFORMATION

This application claims priority to 62/521,597, filed on Jun. 19, 2017, incorporated herein by reference in its entirety.

### BACKGROUND

### Technical Field

The present invention relates to fraud detection and more particularly financial fraud detection using user group behavior analysis.

### Description of the Related Art

A user can engage in a variety of financial activities, such as, e.g., withdrawing or depositing money in a bank account, account logins, money remittances, bill payments, money transfers, and other financial activities and transactions. However, occasionally, an entity may try to fraudulently engage in one or more of these activities in the user's name, thus causing financial losses to the user. However, detecting financial fraud based on preset rules that are globally applied can miss fraudulent behavior for some, or even many users.

### SUMMARY

According to an aspect of the present principles, a method is provided for mitigating fraud in transactions. The method includes clustering account holders into groups with a cluster generator by jointly considering account activities as features in a clustering algorithm such that account holders in each group have similar behavior according to analysis of the features in the clustering algorithm. In each group, a list of suspicious transactions is detected with a suspicious behavior detector by determining outlier transactions for a transaction type of interest relative to transactions of each account holder in a group. An alert is generated and sent to users with a fraud suspicion response system to mitigate the suspicious transactions.

According to another aspect of the present principles, a method is provided for mitigating fraud in transactions. The method includes clustering account holders into groups with a cluster generator by jointly considering account activities as features in a clustering algorithm. In each group, a first list of suspicious transactions is detected with a suspicious amount detector by determining transaction amounts for a transaction type of interest that are greater than an amount threshold from an average transaction amount for account holders in each group. In each group, a second list of suspicious transactions is detected with a suspicious percentage detector by determining transaction percentages for the transaction type of interest that are greater than a percentage threshold from an average transaction percentage for the account holder in each group. In each group, a third list of suspicious transactions is detected with a suspicious account activity detector by jointly considering transaction activity features to determine transaction activity clusters for the transaction type of interest and to identify outliers from the transaction activity clusters. The first list, the second list, and the third list are fused into a final list of suspicious transactions for all the groups. An alert is generated and sent to users with a fraud suspicion response system to mitigate the suspicious transactions.

According to another aspect of the present principles, a system is provided for mitigating fraud in transactions. The system includes an account holder cluster generator for clustering account holders into groups by jointly considering account activities as features in a clustering algorithm such that account holders in each group have similar behavior according to analysis of the features in the clustering algorithm. A suspicious behavior detection system is used for detecting, in each group, a list of suspicious transactions by determining outlier transactions for a transaction type of interest relative to transactions of each account holder in a group. A fraud suspicion response system is for alerting users automatically of the suspicious transactions.

These and other features and advantages will become apparent from the following detailed description of illustrative embodiments thereof, which is to be read about the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for detecting suspicious account activity, in accordance with the present principles;

FIG. 2 is a block/flow diagram illustrating a system/method for detecting suspicious account activity using account holder group behavior analysis, in accordance with the present principles;

FIG. 3 is a block/flow diagram illustrating a system/method for account holder group behavior analysis using a set of detectors for detecting suspicious activity, in accordance with the present principles; and

FIG. 4 is a flow diagram illustrating a system/method for detecting suspicious account activity using account holder group behavior analysis, in accordance with the present principles.

### DETAILED DESCRIPTION OF PREFERRED EMBODIMENTS

In accordance with the present principles, systems and methods are provided for detecting fraudulent financial activity using group behavior analysis.

In one embodiment, fraud with respect to a particular activity, such as, e.g., money remittance, or any other financial activity, is detected using a highly personalized and sophisticated analysis. This analysis includes clustering user activity data for every account holder at a financial institution. The clustering uses a clustering algorithm to identify groups of account holders that tend to have similar behavioral patterns based on their account activities at the financial institution.

Upon clustering, a set of detectors can be employed at each group of account holders to determine the account actions, such as, e.g., particular remittances, that fall outside the norm for account holders in corresponding groups. Such detectors can include, e.g., suspicious remittance amount detectors, suspicious remittance percentage detectors, and suspicious account activity detectors. Each detector is deployed for each group so that the account activities of every account holder in each group is analyzed. Account actions that are not normal, for example, a remittance that is unusually high for the corresponding group, is identified as suspicious. The results from each detector employed can be jointly considered to improve the accuracy of the suspicious activity detection.

Thus, each account action can be compared against the actions of other similar account holders. As a result, the identification of suspicious behaviors is more accurate to the user because it is based on a larger amount of data than just a particular user, while being based on similar users. Accordingly, suspicious activity is more likely to be determined because the analysis is more accurate. Ultimately, account holders and financial institutions can, therefore, save money by detecting fraud earlier.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

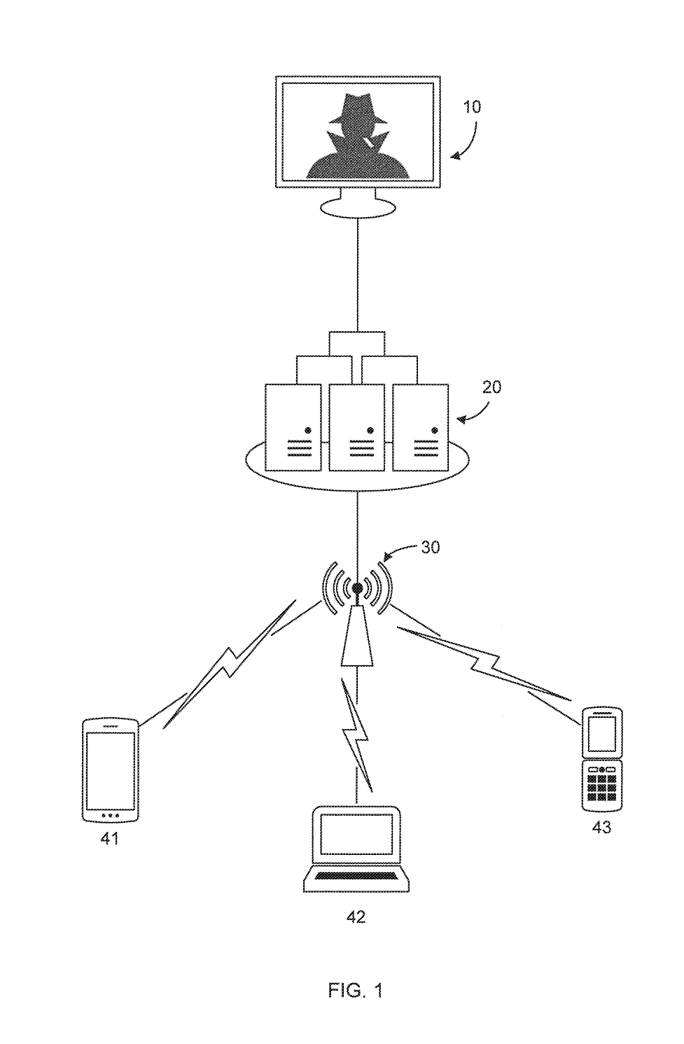

Referring now in detail to the figures in which like numerals represent the same or similar elements and initially to FIG. 1, a high-level system/method for detecting suspicious account activity is illustrated in accordance with one embodiment of the present invention.

According to an embodiment of the present invention, an account access point 10 can be used by an account holder to access their account in a financial system 20, such as, e.g., a bank, a credit union, an investment account, etc. The account access point 10 can be any device used to access the financial system 20. Therefore, the account access point 10 can be, e.g., an online account portal accessed via an internet connected computer, smartphone, tablet, laptop or other internet connected device. The account access point 10 could also be a device having a direct or otherwise private connection to the financial system 10, such as, e.g., an automated teller machine (ATM) or telephone based customer services, or other access point. The account access point 10 could even be a physical location at which an account holder can access their account, such as, e.g., a bank location, or other physical locations.

Once an account is accessed via the account access point 10, a person accessing the account can engage in account activity in the corresponding account in the financial system 20. Thus, a person can perform transactions, such as, e.g., remittances, money transfers, money orders, cash and check withdrawals and deposits, etc. However, sometimes the account activity is fraudulent, or otherwise unlawful, such as, e.g., a third party accessing the account access point 10 without permission to engage in account activity under the guise of the account holder, or money laundering and other illicit financial activities, among others.

The financial system 20 records account activities in the accounts of each account holder. Thus, according to aspects of the present invention, the financial system 20 can include a database for storing records of the account activities, and a system for detecting suspicious activity based on the records in the database. By leveraging a history or records across accounts for various transactions, the financial system 20 can accurately and efficiently analyze the records to determine account activities and transactions that are outliers, or otherwise anomalous, in the context of the database of account activities.

However, analyzing the account activities as a global pool of data to determine outliers can result in false negatives regarding outlier identification. This is because not every account holder can be expected to have the same behavior. An account holder with a high income and high account balance may be expected to, for example, remit more money at a time or more often, than a person with lower income or account balance. Therefore, it can be beneficial for the financial system 20 to generate groups of account holders with similar behaviors to more accurately assess if a given transaction is anomalous. Thus, each transaction can be assessed in a more personalized and appropriate context to determine if it is anomalous.

Upon identifying anomalous behavior, the financial system 20 can classify the behavior as suspicious, and respond to the suspected threat. For example, based on an unusually high amount of a remittance, the financial system 20 may determine that the remittance is suspicious because it might be conducted by someone other than the account holder, or it may be indicative of a financial crime. Thus, the financial system 20 can take appropriate steps.

In one possible embodiment, the financial system 20 can generate an alert of the suspicious transaction and communicate the alert to a communication system 30. Depending on the transaction and the nature of the suspicious activity, the communication system 30 can automatically notify the affected parties. For instance, the communication system 30 can generate and send an alert to account holders or managers of the financial system 20. In such a case, the communication system 30 can automatically generate and send the alert, e.g., over the internet to a smartphone 41 and/or computer 42, among other internet connect devices, via, e.g., email, chat client, web browser with a notification in an account portal, or other method. Alternatively, or in addition, the communication system 30 can send the alert via, e.g., a telecommunication network to a telephone by an automated voice message or a text message, or through other telephone based communication.

While the notification of account holders and managers are discussed above, the financial system 20 can alternatively or in addition, automatically block or freeze transactions and block or freeze accounts at the account access point 10 to prevent the suspicious activity and any further suspicious activity. Accordingly, costly fraudulent account behavior and transactions can be mitigated by the analysis of account activities by the financial system 20.

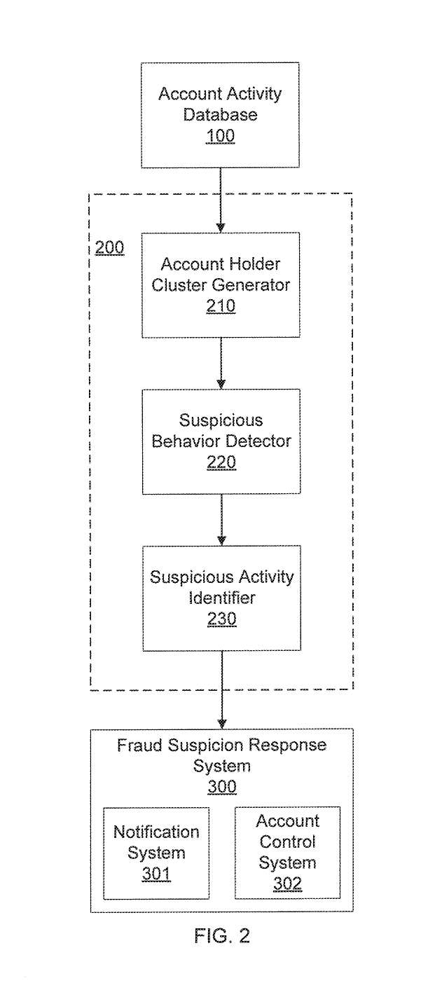

Referring now to FIG. 2, a system/method for detecting suspicious account activity using account holder group behavior analysis is illustratively depicted in accordance with one embodiment of the present principles.

In one embodiment, a financial institution can have a system, such as the financial system 20 discussed above, that maintains a record of account activity corresponding to each account holder in an account activity database 100. The account activity may be generated by, e.g., online banking activities, offline banking activities that are then uploaded to a database, or other suitable way of recording the account activities of an account holder. Account activities can include actions and transactions including, e.g., cash and check deposits and withdrawals, online account logins, automated teller machine (ATM) logins, account balance, money transfers, financial remittances, among other account information.

To prevent or mitigate fraudulent financial activity at the expense of an account holder or the financial institution, the financial institution can analyze the account activities to determine suspicious behavior that would indicate a fraudulent act. Such fraudulent acts can include, e.g., a fraudulent remittance or money transfer, or any other transaction. Accordingly, the data in the account activity database 100 can be communicated to a suspicious behavior detection system 200 that will analyze the data to determine if any particular transaction is an anomaly, and thus indicative of possible fraud.

According to aspects of the present invention, the suspicious behavior detection system 200 can include an account holder cluster generator 210. Because account holders can have widely varying behavior patterns, a single general group of account holders will not provide behavior characteristics that are useful for determining fraud of a particular activity. For example, some account holders may remit a large amount of money every week, while others may remit a small amount every month, along with any other variations in account activities and behavior. Thus, the account holder cluster generator 210 forms clusters of account holders with similar behaviors.

Clustering can be accomplished by extracting multiple behavior related features from account data in the account activity database 100 correspond to each account holder. Such behavior related features can include, e.g., login frequency, login duration, login time, transaction frequency, including remittance frequency and transfer frequency, among other features. Each feature can be used to represent a dimension of account holder behavior. Therefore, the features can be used to correlate behaviors of each account holder to determine a behavioral similarity between account holders.

The account holder cluster generator 210 can determine behavioral similarity using a suitable algorithm for clustering features according to similarity, such as, e.g., spectral clustering, K-means clustering, among other clustering algorithms. Accordingly, the account holder cluster generator 210 can form groups of account holders according to the clustering such that a given account holder is grouped with other similar account holders. This grouping forms a pool of behavior related features corresponding to similar account holders for a more personalized and accurate analysis of financial activity.

Each group can then be separately analyzed by a suspicious behavior detector 220 to detect any suspicious account activities according to normal behaviors for a corresponding group. Normal behaviors can be determined according to numerical evaluation of the account activity data for each account holder in each group. Based on the numerical evaluation, for example, a threshold can be set for a maximum feature of a transaction, and any transaction that exceed the threshold will be considered abnormal, or suspicious. However, other evaluations can be utilized, such as, e.g., density-based clustering or other clustering algorithm, among others.

Based on the analysis of the account activity data of each group, the suspicious behavior detector 220 can determine suspicious behavior that is tailored to each group. Thus, the suspicious behavior detection can be more accurate and less likely to give a false negative for a particular transaction. In fact, the numerical analysis of the account activity data in each group can be adjusted according to a desired level of resistance to false negatives. For example, a lower threshold will determine more transactions as suspicious, and thus warranting further analysis, while a higher threshold will be less likely to detect suspicious activity by broadening what falls within normal behavior.

A suspicious activity identifier 230 can collect the results of the analysis performed by the suspicious behavior detector 220. Upon collecting the results, the suspicious activity identifier 230 can organize the results such that a list of suspicious activity across all account holders can be generated. Thus, the suspicious behavior detection system 200 can generate an actionable list of account behaviors that may be fraudulent without the use of preset rules or human intervention. As a result, the suspicious behavior detection system 200 produces high quality results at lower costs with a greater chance of facilitating fraud mitigation

The list can then be communicated to a fraud suspicion response system 300. The fraud suspicion response system 300 can use the list of suspicious transactions, such as, e.g., suspicious remittances, to take action. According to an aspect of the present invention, the fraud suspicion response system 300 can take the form of a notification system 301, such as, e.g., an alert system, for example, e.g., a communication network including messaging over an internet or telecommunications such as text messaging, auditory alert device, display device, among others, that automatically notifies the financial institution and account holders associated with a particular suspicious transaction of the possible fraud. In another embodiment, the fraud suspicion response system 300 can include, e.g., an account control system 302 for automatically putting an account associated with a suspicious behavior on hold to prevent further fraud. Other fraud suspicion response systems 300, and combinations thereof, are contemplated.

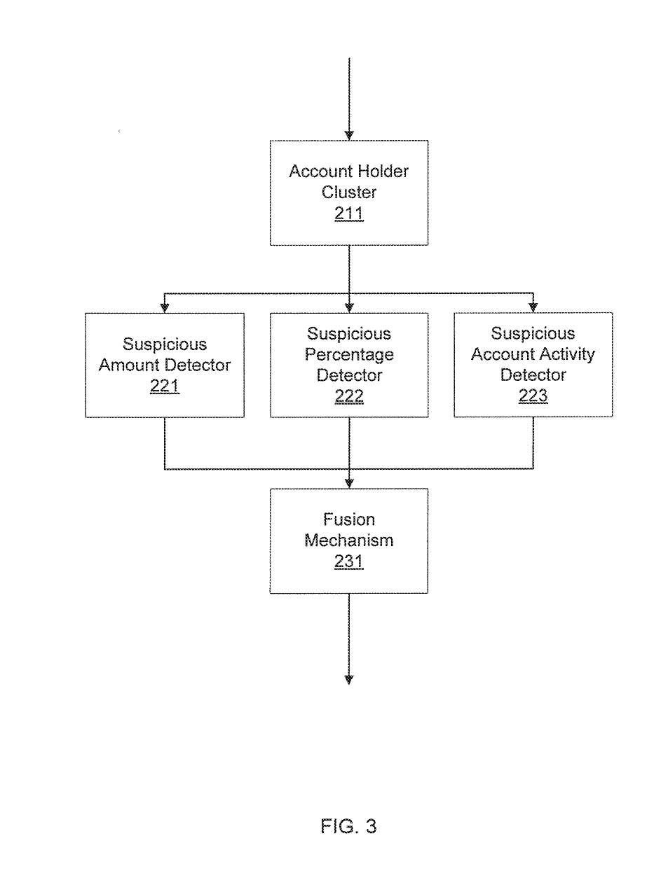

Referring now to FIG. 3, a system/method for account holder group behavior analysis using a set of detectors for detecting suspicious activity is illustratively depicted in accordance with one embodiment of the present principles.

According to aspects of the present invention, the suspicious behavior detector 220 can include more than one detector. For example, the suspicious behavior detector 220 can include, e.g., three behavior detectors, each detector detecting a behavior using different features. Such detectors can include, e.g., a suspicious amount detector 221, a suspicious percentage detector 222 and a suspicious account activity detector 223. Each of the detectors can, e.g., operate in parallel to detect transactions of a given account holder cluster 211 based on the respective feature of interest of each detector. Accordingly, upon clustering account holders into groups, account activity data concerning a given account holder cluster 211 can be provide to each of the suspicious amount detector 221, the suspicious percentage detector 222 and the suspicious account activity detector 223.

The suspicious amount detector 221 will analyze a feature, including, e.g., a monetary amount, for a transaction of a particular type. For example, the suspicious amount detector 221 can be used to detect, e.g., suspicious remittances, however other transactions such as, e.g., cash transfers, withdrawals, deposits, among others are contemplated. Therefore, the suspicious amount detector 221 can receive remittance histories for each account holder in the account holder cluster 211, including, e.g., remittance amounts. Pooling all the remittance amounts for the account holder cluster, the suspicious amount detector 221 can then analyze the remittance amounts based on normal amounts for that account holder cluster 211.

Normal, in this case, may be determined according to a statistical analysis of the remittance, such as, e.g., an analysis based on an average and standard deviation of remittance amount for the account holder cluster 211. Other types of analysis are contemplated, including, e.g., median and standard deviation analysis, regression, analysis of variance (ANOVA), and other forms of data analysis that can determine unusual data points of a group of data points. When using amount averages and standard deviation, a threshold for detecting suspiciousness (“suspicious amount threshold”) can be according to the cluster average remittance amount plus a multiple of the standard deviation, as shown in equation 1 below:

tₐ=μₐ+cσₐ Equation 1:

where tₐ is the suspicious amount threshold for the account holder cluster 211, μₐ is the amount average for the account holder cluster 211, c is a constant for the account holder cluster 211, and σₐ is the standard deviation for the amounts of the account holder cluster 211. The constant, c, can be any suitable constant that is, e.g., predetermined, or adjusted as desired, either manually or automatically. A higher constant, c, will result in a higher suspicious amount threshold, tₐ, and thus fewer transactions will exceed the threshold and be detected as suspicious, limiting false positives. However, a lower constant, c, will result in a lower suspicious amount threshold, tₐ, and thus more transactions will exceed the threshold and be detected as suspicious, resulting in fewer false negatives but requiring action on more transactions. A constant, c, that balances false negatives with false positives can be, e.g., 5. However, a false negative can be much costlier than a false positive because it can permit a bad actor to continue committing fraud and prevents the financial institution from taking action. Therefore, a constant, c, that is biased towards false positives can be used, such as, e.g. a constant, c, of 3. Thus, for any remittance amount that is greater than the cluster average plus three standard deviations (“3-sigma”), the suspicious amount detector 221 will identify the remittance as a suspicious amount, and therefore a suspicious remittance.

The suspicious percentage detector 222 will similarly analyze a feature, including, e.g., a monetary amount ratio, for a transaction of a particular type. For example, the suspicious percentage detector 222 can be used to detect, e.g., suspicious remittances, however other transactions such as, e.g., cash transfers, withdrawals, deposits, among others are contemplated. Therefore, the suspicious percentage detector 222 can receive remittance histories for each account holder in the account holder cluster 211, including, e.g., remittance percentages. Here, a remittance percentage is used to signify the remittance amount divided by an account balance for a given user. Pooling all the remittance percentages for the account holder cluster, the suspicious percentage detector 222 can then analyze the remittance percentages based on normal percentages for that account holder cluster 211.

Similar to above, normal, in this case, may be determined according to a statistical analysis of the remittance, such as, e.g., an analysis based on an average and standard deviation of remittance percentage for the account holder cluster 211. Other types of analysis are contemplated, including, e.g., median and standard deviation analysis, regression, analysis of variance (ANOVA), and other forms of data analysis that can determine unusual data points of a group of data points. When using percentage averages and standard deviation, a threshold for detecting suspiciousness (“suspicious amount threshold”) can be according to the cluster average remittance percentage plus a multiple of the standard deviation, as shown in equation 2 below:

tₚ=μₚ+dσₚ Equation 2:

where tₚ is the suspicious percentage threshold for the account holder cluster 211, μₚ is the percentage average for the account holder cluster 211, d is a constant for the account holder cluster 211, and σₚ is the standard deviation for the percentages of the account holder cluster 211. The constant, d, can be any suitable constant that is, e.g., predetermined, or adjusted as desired, either manually or automatically. A higher constant, d, will result in a higher suspicious percentage threshold, tₚ, and thus fewer transactions will exceed the threshold and be detected as suspicious, limiting false positives. However, a lower constant, d, will result in a lower suspicious percentage threshold, tₚ, and thus more transactions will exceed the threshold and be detected as suspicious, resulting in fewer false negatives but requiring action on more transactions. A constant, d, that balances false negatives with false positives can be, e.g., 5. However, a false negative can be much costlier than a false positive because it can permit a bad actor to continue committing fraud and prevents the financial institution from taking action. Therefore, a constant, d, that is biased towards false positives can be used, such as, e.g. a constant, d, of 3. Thus, any remittance percentage that is greater than the cluster average plus three standard deviations (“3-sigma”), will be identified as a suspicious percentage, and therefore a suspicious remittance.

For each of the suspicious amount detector 221 and the suspicious percentage detector 222 discussed above, all suspicious transactions can be communicated to a fusion mechanism 231. Alternatively, however, for each detector, the detected suspicious remittances can be ranked according to distance from the mean, and only a certain number of the furthest remittances from the average will be selected. The sorting and selection process can be performed, e.g., individually, or by the fusion mechanism 231 upon receiving the suspicious remittances. The amount can be preset or adjusted based on the resources available to take action for each suspicious remittance, for example, only the top 100 can be listed.

Additionally, the suspicious account activity detector 223 can be included. The suspicious account activity detector 223 can analyze multiple features to detect suspicious transactions, such as, e.g., remittances, based on account activity pertaining to each remittance among the account holders in the account holder cluster 211. For example, the suspicious account activity detector 223 can take into account features including, e.g., the number of days since the last activity, the number of days since the last remittance, a ratio of remittance amount to remittance amount plus account balance, the number of unique internet protocol addresses used per login in the past, e.g., 14 days, the proportion of remittances to total account transactions, the amount of activity in a given amount of time, e.g., 14 days, the number of remittances in a given amount of time, e.g., 14 days, among other features and combinations thereof. Each feature can be used to represent a dimension of transaction characteristics. By employing the features as transaction dimensions, the transactions, such as, e.g., remittances or money transfers, etc., can be clustered according to similarity.

According to an aspect of the present invention, the transactions can be clustered using, e.g., a density-based clustering algorithm such as, e.g., density-based spatial clustering of applications with noise (DBSCAN). Thus, major clusters of transactions can be identified that represent similar account activity related to particular transaction for each account holder in the account holder cluster 211. The density-based clustering can further identify the limits of the cluster, thereby forming bounds on which transactions belong to a given cluster. By jointly considering the multiple features to build the density-based clusters of transactions, outliers can be detected that are relatively far from identified major clusters, and therefore identified by the density-based cluster as not part of any major cluster. The outliers, therefore, represent anomalous account activity that is unusual for the account holder cluster 211, and therefore suspicious.

The fusion mechanism 231 receives lists of suspicious transactions, e.g., remittances, from each of the suspicious amount detector 221, the suspicious percentage detector, and the suspicious account activity detector 223. The fusion mechanism 231 can then aggregate each detected suspicious transaction and fuse them into a single list of suspicious transactions. The fusion into a single list can include removing redundancies by checking for a particular transaction being identified by more than one detector, and only keeping one instance of the transaction. Further, the fusion mechanism 231 can add to the list a fused list of detected suspicious transactions for every account holder cluster generated by an account holder cluster generator, such as the account holder cluster generator 210 discussed above. Thus, a final list of detected suspicious activity can be created and sent to a fraud suspicion response system, such as the fraud suspicion response system 300 discussed above.

Therefore, suspicious transactions can be identified quickly and automatically across many account holders. This process would be very slow and inefficient, both computationally and by man-power, if preset rules or human oversight were employed. However, according to aspects of the present invention, neither present rules nor human oversight are needed to identify the suspicious transactions. Moreover, because the account holders are clustered, false negatives concerning suspicious activity can be avoided by analyzing behaviors of account holders in the context of other similar account holders, rather than in the context of a very large and heterogenous group. Thus, a financial institution will have a greater chance to detect suspicious transactions and take action to mitigate potential fraud.

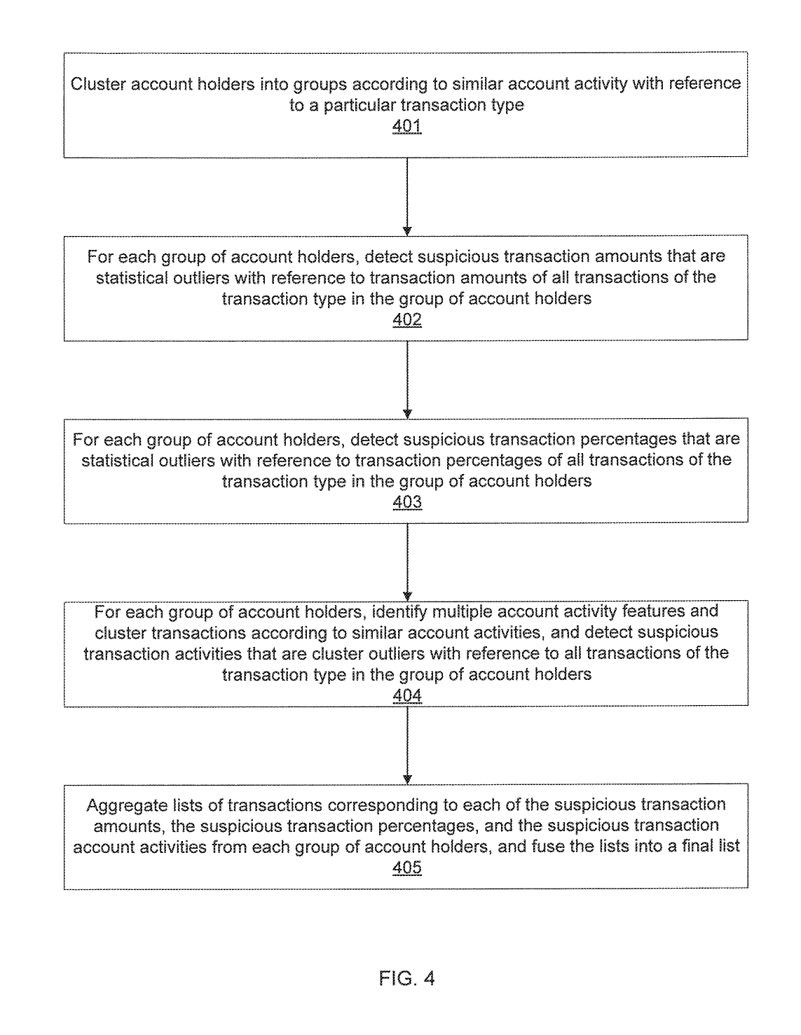

Referring now to FIG. 4, a flow diagram illustrating a system/method for detecting suspicious account activity using account holder group behavior analysis is illustratively depicted in accordance with an embodiment of the present principles.

At block 401, cluster account holders into groups according to similar account activity with reference to a particular transaction type.

Account holders can be clustered into groups by jointly considering a number of account activity features, such as, e.g., login activities, account activities, transaction activities, among others. Jointly considering the account activity features can include clustering with a suitable clustering algorithm, such as, e.g., K-means clustering, spectral clustering, among others. Thus, groups of account holders can be identified where each of the account holders has exhibited and can be expected to exhibit similar behaviors.

At block 402, for each group of account holders, detect suspicious transaction amounts that are statistical outliers with reference to transaction amounts of all transactions of the transaction type in the group of account holders.

A transaction of interest can be identified, such as, e.g., remittances. Therefore, remittance amounts can be collected for each account holder in a given group of account holders, and statistically modelled. The statistical model can identify remittance amount outliers in the group based on, for example, distance from the average of all remittance amounts of the group. An outlier can be detected where a particular remittance amount is more than, e.g., three or five standard deviations greater than the average. The detected outliers can be collected as suspicious remittance amounts to form a list of suspicious remittances.

At block 403, for each group of account holders, detect suspicious transaction percentages that are statistical outliers with reference to transaction percentages of all transactions of the transaction type in the group of account holders.

The transaction of interest can be identified, such as, e.g., remittances. Therefore, remittance percentages can be collected for each account holder in a given group of account holders, and statistically modelled. The remittance percentage can be, e.g. a remittance amount divided by total account balance for an account holder. The statistical model can identify remittance percentage outliers in the group based on, for example, distance from the average of all remittance percentages of the group. An outlier can be detected where a particular remittance percentage is more than, e.g., three or five standard deviations greater than the average. The detected outliers can be collected as suspicious remittance percentages to form another list of suspicious remittances.

At block 404, for each group of account holders, identify multiple account activity features and cluster transactions according to similar account activities, and detect suspicious transaction activities that are cluster outliers with reference to all transactions of the transaction type in the group of account holders.

A set of features related to the transaction of interest, e.g., remittances, can be identified. The features can form dimensions of remittance behavior that can, therefore, be jointly considered to establish clusters of remittances in each group according to similarity of behavior. The clusters of remittances can be established using, e.g., a density-based clustering algorithm, which will identify clusters and edges of the cluster. Thus, outliers that do not fall within the edges of any cluster can be identified as having anomalous behavior, thus indicating suspicious remittances. The suspicious remittances can be included in another list of suspicious remittances.

At block 405, aggregate lists of transactions corresponding to each of the suspicious transaction amounts, the suspicious transaction percentages, and the suspicious transaction account activities from each group of account holders, and fuse the lists into a final list.

Each list of suspicious remittances can be aggregated and fused together. Fusing the lists include removing any redundant remittances that appear as an instance in more than one list. Thus, a single, final list of suspicious remittances can be formed. The list can thereafter be acted upon to mitigate any fraud. Action taken to mitigate fraud can include an automatic action, such as, e.g., an automatic alert to the financial institution or account holders corresponding to the listed remittances, or an automatic freezing of an account corresponding to each of the listed remittances, among other actions. Thus, remittances that may be a result of fraud can be quickly, efficiently and accurately detected such that action can be taken to mitigate the possible fraud and prevent financial losses.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for mitigating fraud in transactions, further comprising:
clustering account holders into groups with a cluster generator by jointly considering account activities as features in a clustering algorithm such that account holders in each group have similar behavior according to analysis of the features in the clustering algorithm;
detecting, in each group with a suspicious behavior detector, a list of suspicious transactions by determining outlier transactions for a transaction type of interest relative to transactions of each account holder in a group; and
generating and sending an alert to users with a fraud response system to mitigate the suspicious transactions.

2. The method as recited in claim 1, wherein the detecting with the suspicious behavior detector includes:
detecting a suspicious amount with a suspicious amount detector by comparing transaction amounts among each account holder in each of the groups;
detecting a suspicious percentage with a suspicious percentage detector by comparing transaction percentages among each account holder in each of the groups, wherein the transaction percentages are based on a percentage of an account balance corresponding to a transaction amount; and
detecting a suspicious account activity with a suspicious account activity detector by jointly comparing a plurality of account activity features among each account holder in each of the groups.

3. The method as recited in claim 2, wherein the transaction amounts are compared among each account holder in each of the groups by determining transaction amounts for the transaction type of interest that are greater than an amount threshold from an average transaction amount for account holders in each group.

4. The method as recited in claim 3, wherein the amount threshold is between about 3 and about 5 standard deviations greater than the average transaction amount.

5. The method as recited in claim 2, wherein the transaction percentages are compared among each account holder in each of the groups by determining transaction percentages for the transaction type of interest that are greater than a percentages threshold from an average transaction percentage for account holders in each group.

6. The method as recited in claim 5, wherein the percentage threshold is between about 3 and about 5 standard deviations greater than the average transaction amount.

7. The method as recited in claim 2, wherein the plurality of account activity features are compared by jointly considering the account activity features as dimensions for each transaction in a density-based algorithm.

8. The method as recited in claim 1, wherein the transaction type of interest includes remittances.

9. The method as recited in claim 1, wherein the clustering algorithm includes an algorithm selected from the group consisting of spectral clustering and K-means clustering.

10. A method for mitigating fraud in transactions, comprising:
clustering account holders into groups with a cluster generator by jointly considering account activities as features in a clustering algorithm;
detecting, in each group with a suspicious amount detector, a first list of suspicious transactions by determining transaction amounts for a transaction type of interest that are greater than an amount threshold from an average transaction amount for account holders in each group;
detecting, in each group with a suspicious percentage detector, a second list of suspicious transactions by determining transaction percentages for the transaction type of interest that are greater than a percentage threshold from an average transaction percentage for the account holder in each group;
detecting, in each group with a suspicious account activity detector, a third list of suspicious transactions by jointly considering transaction activity features to determine transaction activity clusters for the transaction type of interest and to identify outliers from the transaction activity clusters; and
fusing the first list, the second list, and the third list into a final list of suspicious transactions for all the groups; and
generating and sending an alert to users with a fraud response system to mitigate the suspicious transactions.

11. The method as recited in claim 10, wherein the transaction type of interest includes remittances.

12. The method as recited in claim 10, wherein the clustering algorithm includes an algorithm selected from the group consisting of spectral clustering and K-means clustering.

13. The method as recited in claim 10, wherein the amount threshold is between about 3 and about 5 standard deviations greater than the average transaction amount.

14. The method as recited in claim 10, wherein the percentage threshold is between about 3 and about 5 standard deviations greater than the average transaction amount.

15. The method as recited in claim 10, further including sending a text message to an account holder regarding a suspicious transaction in the final list corresponding to an account of the account holder.

16. The method as recited in claim 10, further including freezing an account for an account holder corresponding to a suspicious transaction in the final list.

17. A system for mitigating fraud in transactions, comprising:
an account holder cluster generator for clustering account holders into groups by jointly considering account activities as features in a clustering algorithm such that account holders in each group have similar behavior according to analysis of the features in the clustering algorithm;
a suspicious behavior detection system for detecting, in each group, a list of suspicious transactions by determining outlier transactions for a transaction type of interest relative to transactions of each account holder in a group; and
a fraud suspicion response system for alerting users automatically of the suspicious transactions.

18. The system as recited in claim 17, wherein the suspicious behavior detection system includes:
a suspicious amount detector for comparing transaction amounts among each account holder in each of the groups;
a suspicious percentage detector for comparing transaction percentages among each account holder in each of the groups, wherein the transaction percentages are based on a percentage of an account balance corresponding to a transaction amount; and
a suspicious account activity detector for jointly comparing a plurality of account activity features among each account holder in each of the groups.

19. The system as recited in claim 17, wherein the fraud suspicion response system includes a notification system for automatically alerting an account holder about a suspicious transaction in the list corresponding to an account for the account holder.

20. The system as recited in claim 17, wherein the transaction type of interest includes remittances.
